(19) United States
(12) Patent Application Publication
(10) Pub. No.: US 2025/0371913 A1
(43) Pub. Date: Dec. 4, 2025

(54) ABNORMALITY IDENTIFICATION ASSIST SYSTEM AND LEARNING METHOD

(71) Applicant: SUBARU CORPORATION, Tokyo (JP)

(72) Inventor: Kaito SAKOGAWA, Tokyo (JP)

(21) Appl. No.: 19/185,634

(22) Filed: Apr. 22, 2025

(30) Foreign Application Priority Data
May 28, 2024 (JP) 2024-086303

(51) Int. Cl. G07C 5/00; G07C 5/08

(52) U.S. Cl. CPC G07C 5/006; G07C 5/008; G07C 5/0808; G07C 5/0825

(57) ABSTRACT

An abnormality identification assist system includes an artificial intelligence processor, at least one processor, and a storage medium. The artificial intelligence processor is configured to use a malfunction code output from a vehicle as input and to infer an abnormal part of the vehicle in which an abnormality is occurring and a category of the abnormality. The storage medium is configured to store a program configured to be executed by the at least one processor. The program includes at least one command configured to cause the at least one processor to execute processing for inputting the malfunction code output from the vehicle into the artificial intelligence processor and instructing the artificial intelligence processor to infer the abnormal part in which the abnormality is occurring and the category of the abnormality corresponding to the input malfunction code.

### CROSS-REFERENCE TO RELATED APPLICATIONS

The present application claims priority from Japanese Patent Application No. 2024-086303 filed on May 28, 2024, the entire contents of which are hereby incorporated by reference.

### BACKGROUND

The disclosure relates to an abnormality identification assist system that assists a user with identifying the content of abnormality occurring in a vehicle and also to a learning method for artificial intelligence (AI) used for the abnormality identification assist system.

Typically, a commercially available vehicle is equipped with a malfunction diagnosis function called on-board diagnostics (OBD). When a malfunction is detected in a vehicle, a malfunction code called diagnostic trouble code (DTC), which is defined in accordance with the content of the detected malfunction, is recorded in the vehicle.

Such a malfunction code, which is the DTC, is used to identify the content of abnormality occurring in a vehicle in a vehicle maintenance facility, such as a vehicle dealer, and a vehicle assembly plant, for example.

In a vehicle maintenance facility, for example, when a malfunctioning vehicle is brought to the facility, a malfunction diagnosis device is coupled to this vehicle and causes the vehicle to output a malfunction code. Then, based on this malfunction code, an operator of this facility identifies the content of abnormality occurring in the vehicle.

In a vehicle assembly plant, for example, an operator assembles a vehicle by attaching various parts, such as electronic control units (ECUs) and harness, to a vehicle body. There may be a case in which such a completed vehicle does not operate properly due to a human error or a malfunction of a part of the vehicle, for example. Such a malfunctioning vehicle is brought to a rework line, and an operator checks what is wrong with the vehicle to identify the specific content of abnormality and fixes a problem. The above-described malfunction code as DTC is used to identify the content of abnormality occurring in the vehicle.

To identify the content of abnormality, the operator checks information represented by a malfunction code and estimates the content of abnormality from a combination of codes. However, many ECUs are installed in a vehicle and many types of malfunction codes may be detected in each ECU. The number of combinations of malfunction codes that may be recorded in the vehicle upon the occurrence of abnormality is enormous. It is thus difficult for the operator to identify the content of abnormality directly from a combination of malfunction codes. In most cases, the operator depends on his/her experience and intuition.

Japanese Unexamined Patent Application Publication (JP-A) No. 2006-226805 discloses the following technology. An abnormal part estimation table is stored in a vehicle. In this table, combinations of diagnosis codes (malfunction codes) and parts of the vehicle are related to each other. In more details, a combination of diagnosis codes representing a certain abnormality and a part of the vehicle that may cause this abnormality when these diagnosis codes are detected at the same time are related to each other. When multiple diagnosis codes representing a certain abnormality are detected at the same time, the part of the vehicle that may cause this abnormality is identified based on this table.

This technology makes it possible to identify the content of abnormality without depending on the experience or the intuition of an operator.

### SUMMARY

An aspect of the disclosure provides an abnormality identification assist system. The abnormality identification assist system includes an artificial intelligence processor, at least one processor, and a storage medium. The artificial intelligence processor is configured to use a malfunction code output from a vehicle as input and to infer an abnormal part of the vehicle in which an abnormality is occurring and a category of the abnormality. The storage medium is configured to store a program configured to be executed by the at least one processor. The program includes at least one command configured to cause the at least one processor to execute processing for inputting the malfunction code output from the vehicle into the artificial intelligence processor and instructing the artificial intelligence processor to infer the abnormal part in which the abnormality is occurring and the category of the abnormality corresponding to the input malfunction code.

An aspect of the disclosure provides a learning method. The learning method includes: conducting machine learning for artificial intelligence by using a malfunction code output from a vehicle as input data for learning and by using an abnormal part of the vehicle in which an abnormality has occurred and a category of the abnormality as supervisor data; and generating artificial intelligence configured to infer the abnormal part and the category of the abnormality corresponding to the input malfunction code.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates an abnormality identification assist environment in an embodiment;

FIG. 2 is a block diagram illustrating an example of the hardware configuration of an abnormality identification assist system of the embodiment;

FIG. 3 illustrates an example of history information indicating the correlations of malfunction codes to abnormal parts and categories of abnormalities;

FIGS. 4A and 4B illustrate an AI learning method in the embodiment;

FIG. 5 is a block diagram for illustrating the functions of the abnormality identification assist system in the embodiment; and

FIG. 6 illustrates a display example of information on the inference results of abnormal parts and categories of abnormalities.

### DETAILED DESCRIPTION

Practically speaking, it is difficult to create the abnormal part estimation table disclosed in JP-A No. 2006-226805. As described above, the number of combinations of malfunction codes is enormous. To handle all the abnormalities that may occur in a vehicle, the amount of information of this table becomes massive. Creating such a table is thus very difficult and is not practical.

Another approach may be taken to identify the content of abnormality occurring in a vehicle. History information indicating the correlations between malfunction codes output from a vehicle for abnormalities having occurred in the vehicle in the past and information suggesting the contents of abnormalities, such as parts in which an abnormality is detected by a user, is created. When a malfunction is detected, the content of abnormality regarding this malfunction is identified based on this history information.

With this approach using the history information, however, when a malfunction code that has not been input before is received, a user is unable to identify the content of abnormality corresponding to this malfunction code.

It is thus desirable to improve the assisting performance of an abnormality identification assist system that assists with identifying the content of abnormality occurring in a vehicle by allowing the abnormality identification assist system to generate information suggesting the content of abnormality even when a malfunction code that has not been input before is received.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

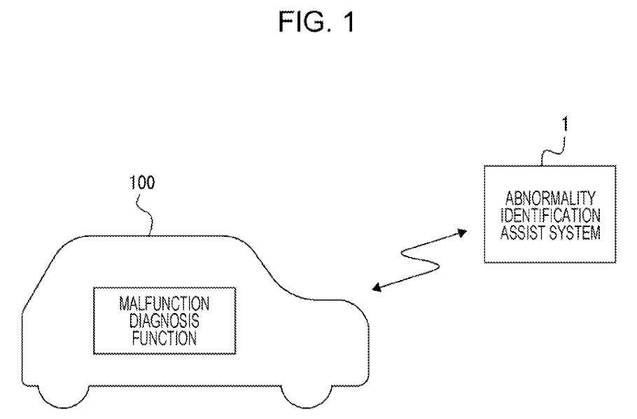

FIG. 1 illustrates an abnormality identification assist environment in the embodiment.

In FIG. 1, a vehicle 100 is a subject for which the content of an abnormality occurring in the vehicle 100 is to be identified. In the embodiment, the vehicle 100 is equipped with a malfunction diagnosis function called on-board diagnostics (OBD). With this function, when a malfunction is detected, a malfunction code called diagnostic trouble code (DTC), which is defined in accordance with the content of the detected malfunction, is recorded in the vehicle 100.

It is assumed that an abnormality identification assist system 1 is installed on site where the content of abnormality of the vehicle 100 is to be identified and is used by an operator who does this work. An example of such a site is an assembly plant for the vehicle 100.

In the assembly plant, at a predetermined timing in an assembly process, such as when the assembling of the vehicle 100 has been completed, the operator causes the vehicle 100 to conduct malfunction diagnosis and to record malfunction diagnosis results.

If the occurrence of a malfunction is detected in the vehicle 100 as a result of conducting malfunction diagnosis, the vehicle 100 is brought to a rework line in the plant, and the specific content of abnormality is identified. In this example, the abnormality identification assist system 1 is used by the operator to do work for identifying the content of abnormality in the rework plant.

The abnormality identification assist system 1 assists the operator with identifying the content of abnormality in the following manner. The abnormality identification assist system 1 first obtains a malfunction code recorded as a malfunction diagnosis result from the vehicle 100. The abnormality identification assist system 1 then generates information suggesting the specific content of abnormality occurring in the vehicle 100 (such information will be called abnormality content suggesting information), based on the malfunction code, and then presents the abnormality content suggesting information to the operator.

In one example, based on the malfunction code obtained from the vehicle 100, the abnormality identification assist system 1 of this embodiment determines a part of the vehicle 100 in which an abnormality is occurring (hereinafter such a part will simply be called an abnormal part) and a category of this abnormality as the abnormality content suggesting information.

The definitions of "abnormal part", "category of abnormality", and "content of abnormality" used in the specification are as follows.

"Abnormal part" is a part of the vehicle 100 obtained by largely classifying the components of the vehicle 100 into some groups. Abnormalities found on the exterior of the vehicle 100, such as flaws having occurred during the assembly process, can be visually identified by the operator. In the embodiment, as an abnormality of the vehicle 100 whose content is to be identified, an internal abnormality occurring in the vehicle 100 is identified. "Abnormal part" thus indicates an internal part of the vehicle 100 classified as described above. Specific examples of "abnormal part" at least include parts categorized based on the type of electronic control unit (ECU), such as an engine ECU, a transmission ECU, a door ECU, and a camera ECU.

"Category of abnormality" indicates the same type of abnormality that can occur in multiple parts of the vehicle 100 among abnormalities occurring during the assembly process. For example, abnormalities occurring in the assembly process include an abnormality that can occur in any part of the vehicle 100, such as forgetting to connect a connector, loose connection of a connector, and a break in harness. An abnormality that can occur in any part of the vehicle 100 is "category of abnormality".

"Content of abnormality" is the specific content of abnormality actually occurring in the vehicle 100. One example of "content of abnormality" is that the n-th connector of the transmission ECU is loosely connected. As another example, software A is supposed to be written into the engine ECU, but different software is written by mistake.

It is noted that, as malfunction codes to be recorded by OBD, various codes representing the contents of malfunctions are defined for each ECU of the vehicle 100. Upon the occurrence of a malfunction, not only a single code, but also, a combination of multiple codes, may be recorded.

The abnormality identification assist system 1 of the embodiment detects an abnormal part and a category of abnormality from a malfunction code by using artificial intelligence (AI). This will be discussed later in detail.

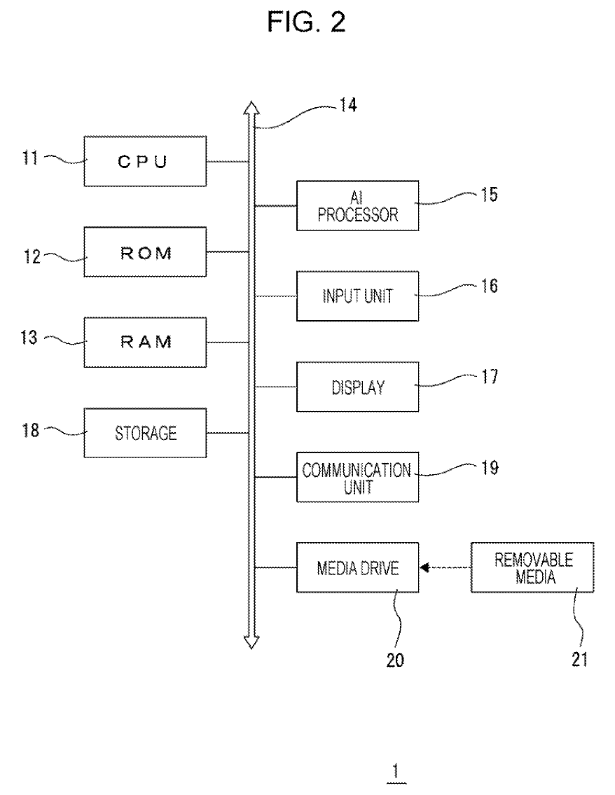

FIG. 2 is a block diagram illustrating an example of the hardware configuration of the abnormality identification assist system 1.

The abnormality identification assist system 1 is not limited to a specific device mode. For example, the abnormality identification assist system 1 may be a general-purpose computer device, such as a personal computer (PC), a tablet terminal, and a smartphone, that can be used for a purpose other than for assisting an operator with identifying the content of abnormality. Alternatively, the abnormality identification assist system 1 may be a dedicated computer device specially used for assisting with identifying the content of abnormality.

As illustrated in FIG. 2, the abnormality identification assist system 1 includes a central processing unit (CPU) 11. The CPU 11 executes various processing operations in accordance with a program stored in a read only memory (ROM) 12 or a program loaded from a storage 18 into a random access memory (RAM) 13. In the RAM 13, data, for example, to be used by the CPU 11 to execute various processing operations is also stored.

The CPU 11, the ROM 12, and the RAM 13 are coupled with each other via a bus 14.

An AI processor 15 is also coupled to the bus 14.

The AI processor 15 executes inference processing to assist with identifying the content of abnormality by using learned AI. In one example, the AI processor 15 uses a malfunction code output from the vehicle 100 as input and infers an abnormal part of the vehicle 100 and a category of abnormality occurring in the vehicle 100.

In this example, as the architecture of the AI processor 15, a deep neural network (DNN) is employed, and an AI model that implements the above-described inference is created by deep learning.

A specific learning method and an example of the configuration of the AI processor 15 in the embodiment will be discussed later.

An input unit 16, a display 17, a storage 18, a communication unit 19, and a media drive 20 are coupled to the bus 14.

The input unit 16 is constituted by an operation unit or an operation device. As the input unit 16, various operation units and operation devices, such as a keyboard, a mouse, a key, a dial, a touchscreen, a touch pad, and a remote controller, may be used.

An operation performed by a user is detected by the input unit 16 and a signal indicating the input operation is interpreted by the CPU 11.

The display 17 is constituted by a display panel that can display an image, such as a liquid crystal display (LCD) panel or an organic electroluminescence (EL) panel, and is used for displaying various items of information. In this example, the display 17 is a display device provided on the housing of the abnormality identification assist system 1. However, the display 17 may be a display device provided outside the abnormality identification assist system 1.

The display 17 displays various images on a display screen, based on an instruction from the CPU 11. In one example, in the embodiment, the display 17 is used for displaying information indicating inference results of the AI processor 15. The display 17 is also able to display images that can be used as graphical user interfaces (GUIs), such as a menu of various operations, icons, and messages, based on an instruction from the CPU 11.

The storage 18 is constituted by a solid state memory such as a solid state drive (SSD) and a relatively large capacity storage device, for example, a hard disk drive (HDD), and is used for storing various items of information.

The communication unit 19 is able to perform wired or wireless communication and communication via a network transmission path, such as the internet and a local area network (LAN), with various external devices. In the embodiment, the communication unit 19 is able to perform wireless (or may be wired) communication with the vehicle 100, and malfunction codes recorded in the vehicle 100 are input into the abnormality identification assist system 1 via the communication unit 19.

The media drive 20 can removably attach a removable media 21, such as a magnetic disk, an optical disc, a magneto-optical disc, or a semiconductor memory, and can read and write data from and into the attached removable media 21.

The media drive 20 can read from the removable media 21 a data file of a program used for executing various processing operations, for example. The read data file may be stored in the storage 18 or images in the data file may be displayed on the display 17. A computer program, for example, read from the removable media 21 may be installed in the storage 18 according to the necessary.

In the abnormality identification assist system 1 having the above-described hardware configuration, software for executing processing in the embodiment can be installed via network communication performed by the communication unit 19 or via the removable media 21. Alternatively, this software may be prestored in the ROM 12 or the storage 18, for example.

As a result of the CPU 11 executing processing operations based on various programs, the abnormality identification assist system 1 is able to execute information processing and communication processing.

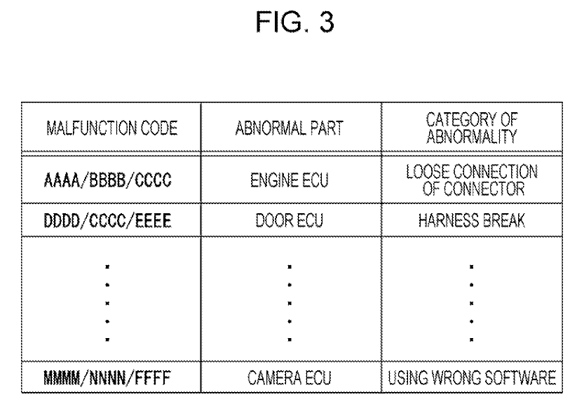

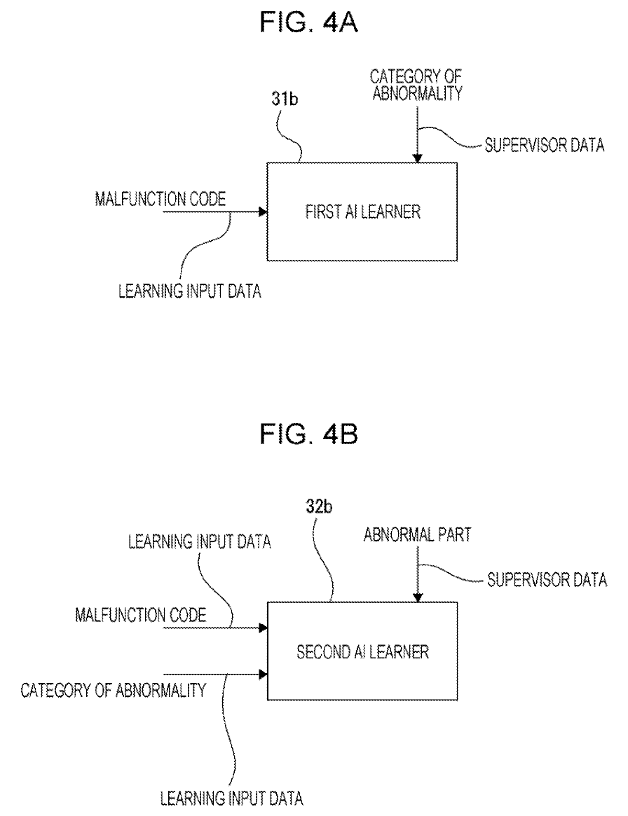

The learning method for AI that infers an abnormal part and a category of abnormality from a malfunction code will be explained below with reference to FIGS. 3, 4A, and 4B.

As the basic concept of learning, history information indicating the correlations of malfunction codes to abnormal parts and categories of abnormalities is used as learning data.

In one example, it is now assumed that, as in this example, the abnormality identification assist system 1 is used in a vehicle assembly plant for assisting an operator with identifying the content of abnormality. In the assembly plant, history information indicating the correlations of the malfunction codes representing the abnormalities occurred in the past to the abnormal parts and the categories of these abnormalities is stored in a list format, for example.

FIG. 3 illustrates an example of such history information.

Before starting learning, data sets for learning are first created from this history information. In one example, for each malfunction code indicated in the history information, the corresponding abnormal part and category of abnormality are related with the malfunction code as ground truth data.

It may be possible to infer an abnormal part and a category of abnormality corresponding to a malfunction code by using a single AI model. Nevertheless, inferring an abnormal part and a category of abnormality by using a single AI model makes it more difficult for this AI model to solve a problem. This may lower the learning efficiency and thus decrease the inference accuracy. This may also enlarge the network size, that is, the required resources are increased.

To address this issue, in the embodiment, the AI model is divided into a first AI model 31 and a second AI model 32. The first AI model 31 infers only a category of abnormality by using a malfunction code as input data. The second AI model 32 infers an abnormal part by using the malfunction code and the category of abnormality inferred by the first AI model 31 as input data.

Dividing an AI model in this manner can make it far less difficult for each AI model to solve a problem. In one example, the first AI model 31 infers only the category of abnormality, which makes it less difficult to solve the problem. In another example, the second AI model 32 can use, not only the malfunction code, but also the category of abnormality as auxiliary information, to infer the abnormal part, which makes it less difficult to solve the problem. This enhances the learning efficiency of each AI model and further improves the inference accuracy. This also reduces the network size of each AI model, which leads to a much smaller network size of the AI processor 15, thereby decreasing the required resources.

FIGS. 4A and 4B illustrate a learning method for creating the first AI model 31 and that for the second AI model 32.

FIG. 4A illustrates the learning method for the first AI model 31. As illustrated in FIG. 4A, a first AI learner 31b for creating the first AI model 31 is first prepared. A malfunction code indicated in the above-described history information is input into the first AI learner 31b as input data for learning, and the category of abnormality related to the input malfunction code as ground truth data is input into the first AI learner 31b as supervisor data. Then, machine learning is conducted as deep learning.

As a result, the first AI model 31 that infers a category of abnormality from a malfunction code can be created.

FIG. 4B illustrates the learning method for the second AI model 32. As illustrated in FIG. 4B, a second AI learner 32b for creating the second AI model 32 is first prepared. A malfunction code indicated in the above-described history information and the category of abnormality related to this malfunction code as ground truth data are input into the second AI learner 32b as input data for learning. The abnormal part related to this malfunction code as ground truth data is input into the second AI learner 32b as supervisor data. Then, machine learning is conducted as deep learning.

As a result, the second AI model 32 that infers an abnormal part from a combination of a malfunction code and a category of abnormality can be created.

In the embodiment, the number of categories of abnormalities to be inferred by the first AI model 31 is set to be smaller than the number of abnormal parts to be inferred by the second AI model 32. In one example, the number of categories of abnormalities are seven in the above-described example: a break in harness, forgetting to connect a connector, loose connection of a connector, malfunctioning of a connector, connecting a connector to a wrong element, using wrong software (writing wrong software), and bending of a pin. In contrast, abnormal parts at least include parts of the vehicle 100 categorized based on the type of ECU, as stated above, and several tens to about one hundred abnormal parts are determined by categorization.

Since the second AI model 32 uses information on the category of abnormality inferred by the first AI model 31 as auxiliary information, the inference accuracy of the second AI model 32 is dependent on the reliability of information on the category of abnormality input from the first AI model 31. With the above-described configuration, the first AI model 31 makes inferences based on a smaller number of candidates than those used by the second AI model 32, thereby making the problem to be solved by the first AI model 31 easier. As a result, the inference accuracy of the first AI model 31 is improved, that is, the reliability of information on the category of abnormality to be obtained as an inference result is enhanced.

Hence, the inference accuracy of the second AI model 32 is also enhanced, which leads to an improvement in the overall inference accuracy of the AI processor 15, that is, the inference accuracy for the categories of abnormalities and abnormal parts is improved.

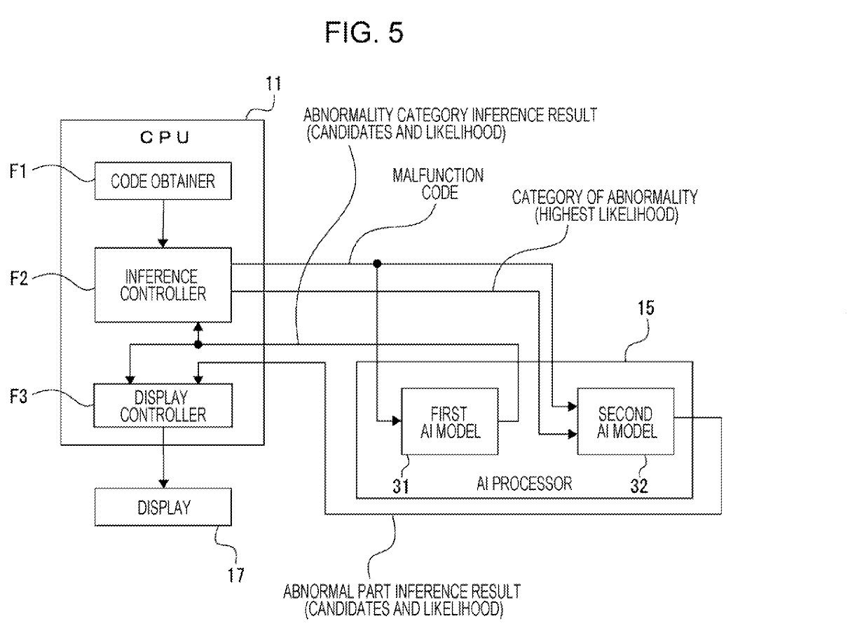

FIG. 5 is a block diagram for illustrating the functions of the abnormality identification assist system 1 in the embodiment.

In FIG. 5, the functional blocks of the CPU 11 of the abnormality identification assist system 1 are illustrated, together with the AI processor 15 and the display 17.

As illustrated in FIG. 5, the CPU 11 includes a code obtainer F1, an inference controller F2, and a display controller F3 as functions.

The AI processor 15 includes the first AI model 31 and the second AI model 32.

The code obtainer F1 of the CPU 11 obtains a malfunction code from the vehicle 100.

The inference controller F2 inputs the malfunction code obtained by the code obtainer F1 into the AI processor 15 and causes it to infer the abnormal part and the category of abnormality corresponding to the malfunction code.

In one example, the inference controller F2 in the embodiment inputs the malfunction code into the first AI model 31 of the AI processor 15 as input data and causes the first AI model 31 to infer the category of abnormality.

A typical AI model generates information on multiple candidates that may be a correct answer and information on the likelihood of each candidate as information indicating the inference results. For example, an AI model performing image recognition first divides targets into some classes, such as "people", "dogs", and "cats". Then, the AI model generates information on the individual classes, such as "people", "dogs", and "cats", and information on the likelihood of each class, as information indicating the inference results.

From the first AI model 31, too, information on multiple candidates of the category of abnormality and information on the likelihood of each candidate are obtained as information indicating the reference results.

The inference controller F2 receives information on multiple candidates of the category of abnormality and information on the likelihood of each candidate as the inference results from the first AI model 31 and determines the candidate having the highest likelihood as information on the category of abnormality to be provided to the second AI model 32 as auxiliary information.

Then, the inference controller F2 inputs information on the category of abnormality having the highest likelihood determined as described above and the malfunction code obtained by the code obtainer F1 into the second AI model 32 as input data and causes the second AI model 32 to infer the abnormal part.

It is noted that, as information indicating the inference results of the second AI model 32, too, information on multiple candidates and information on the likelihood of each candidate are obtained.

The display controller F3 inputs information on the inference results of the category of abnormality (candidates and likelihood) obtained by the first AI model 31 and information on the inference results of the abnormal part (candidates and likelihood) obtained by the second AI model 32 into the display 17 and causes it to display such items of information on a display screen 17a of the display 17.

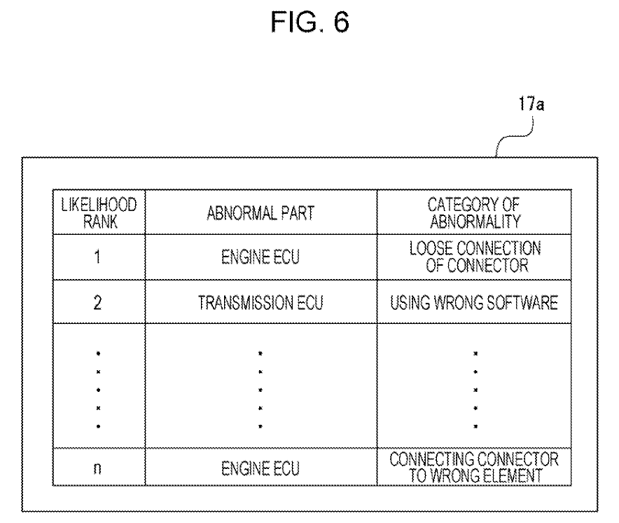

FIG. 6 illustrates a display example of the above-described information indicating the inference results of the abnormal part and the category of abnormality.

As the information indicating the inference results illustrated in FIG. 6, the candidates of the abnormal part and those of the category of abnormality may be displayed in descending order of the likelihood.

When presenting the abnormal part and the category of abnormality corresponding to a malfunction code to the operator, only the abnormal part having the highest likelihood and the category of abnormality having the highest likelihood which are determined in response to the input of the malfunction code may be presented to the operator. In this case, however, if there is an error in the determined abnormal part and category of abnormality, it is highly difficult for the operator to identify the content of abnormality from this abnormal part and category of abnormality. If, as discussed above, multiple candidates that may be a correct answer are displayed as the abnormal part and the category of abnormality, the operator is able to identify the content of abnormality from the displayed multiple candidates even if the displayed likelihood ranks are not correct. For example, even if the content of abnormality estimated by the operator from the abnormal part and the category of abnormality having the highest likelihood is not actually occurring, the operator is still able to estimate the content of another abnormality from the abnormal part and the category of abnormality having the second highest likelihood. The content of this abnormality may be the abnormality that is actually occurring. In this manner, the operator is able to identify the correct content of abnormality even if the displayed likelihood ranks are not correct.

This makes it easier for the operator to identify the actual content of abnormality. In this manner, the assisting performance of the abnormality identification assist system 1 to assist with identifying the content of abnormality can be improved.

When displaying information indicating the inference results, multiple candidates of the abnormal part and the category of abnormality may not necessarily be displayed in descending order of the likelihood as in the above-described example. In terms of addressing the issue regarding the disadvantage of displaying only one candidate having the highest likelihood, displaying of multiple candidates may be sufficient. In this sense, the candidates may not be necessarily displayed in order of the likelihood. For example, only a small number of candidates up to the second or third highest likelihood may be displayed not in order of the likelihood.

The embodiment is not limited to the above-described specific examples and may be modified as various modified examples.

For example, in the above-described embodiment, an inference device that infers the abnormal part and the category of abnormality based on a malfunction code includes a function of obtaining a malfunction code from the vehicle 100 and a function of displaying inference results. However, at least one of these functions may be implemented in a device other than the inference device.

In the above-described embodiment, processing of the inference controller F2 is executed by the single processor, which is the CPU 11. However, multiple processors may execute this processing in a distributed manner.

In the above-described example, the abnormality identification assist system according to an embodiment of the disclosure is used in a vehicle assembly plant to assist an operator with identifying the content of abnormality. However, the abnormality identification assist system according to an embodiment of the disclosure may also be used in a vehicle maintenance facility, such as a vehicle dealer, for the same purpose. The abnormality identification assist system can find widespread application for assisting with identifying the content of abnormality from a malfunction code obtained by the malfunction diagnosis function of a vehicle.

As described above, an abnormality identification assist system 1 according to an embodiment of the disclosure includes an AI processor 15. The AI processor 15 uses a malfunction code output from a vehicle 100 as input and infers an abnormal part of the vehicle 100 in which an abnormality is occurring and a category of this abnormality. The abnormality identification assist system 1 also includes one or multiple processors (hereinafter simply called the processor) and a storage medium that stores a program to be executed by the processor. The program includes one or multiple commands (hereinafter simply called the command) that causes the processor to execute processing for inputting a malfunction code into the AI processor and instructing the AI processor to infer an abnormal part in which an abnormality is occurring and a category of this abnormality corresponding to the malfunction code.

By using the above-described AI processor, even if a malfunction code that has not been input before is received, the abnormal part and the category of abnormality corresponding to this malfunction code can be determined by the inference function of the AI processor.

It is thus possible to improve the assisting performance of the abnormality identification assist system to assist with identifying the content of abnormality.

In the abnormality identification assist system, the command causes the processor to execute inference result display processing for causing a display to display information indicating an inference result obtained by the AI processor.

This enables an operator to visually recognize information indicating the inference result about the abnormal part and the category of abnormality.

Even in a loud environment, such as in a vehicle assembly plant, the operator is able to recognize the inference result. In this manner, the abnormality identification assist system can suitably assist the operator with identifying the content of abnormality.

In the abnormality identification assist system, in the inference result display processing, the processor causes the display to display information indicating multiple candidates for each of the abnormal part and the category of abnormality which are obtained by the AI processor as the inference result.

By displaying multiple candidates, even if the content of abnormality estimated based on one pair of candidates of the abnormal part and the category of abnormality is not actually occurring, the actual content of abnormality may be estimated based on another pair of candidates of the abnormal part and the category of abnormality.

This makes it easier for the operator to identify the actual content of abnormality. In this manner, the assisting performance of the abnormality identification assist system 1 to assist with identifying the content of abnormality can be improved.

In the abnormality identification assist system, the AI processor includes a first AI model 31 and a second AI model 32. The first AI model 31 is learned to infer the category of abnormality from a malfunction code as a result of conducting machine learning by using a malfunction code as input data and the category of abnormality as supervisor data. The second AI model 32 is learned to infer the abnormal part from a combination of the malfunction code and the category of abnormality as a result of conducting machine learning by using the malfunction code and the category of abnormality as input data and the abnormal part as supervisor data. The first AI model infers the category of abnormality corresponding to an input malfunction code, which is a malfunction code input as input data, while the second AI model infers the abnormal part by using the input malfunction code and the category of abnormality inferred by the first AI model as input data.

Dividing an AI model into an AI model that infers the category of abnormality and an AI model that infers the abnormal part can make it far less difficult for each AI model to solve a problem. This enhances the learning efficiency of each AI model and further improves the inference accuracy. This also reduces the network size of each AI model, which leads to a much smaller network size of the AI processor, thereby decreasing the required resources.

In the abnormality identification assist system, the number of categories of abnormalities to be inferred by the first AI model is smaller than the number of abnormal parts to be inferred by the second AI model.

Since the second AI model uses information on the category of abnormality inferred by the first AI model as auxiliary information, the inference accuracy of the second AI model is dependent on the reliability of information on the category of abnormality input from the first AI model. With the above-described configuration, the first AI model makes inferences based on a smaller number of candidates than those used by the second AI model, thereby making the problem to be solved by the first AI model easier. As a result, the inference accuracy is improved, that is, the reliability of information on the category of abnormality to be obtained as an inference result is enhanced.

Hence, the inference accuracy of the second AI model is also enhanced, which leads to an improvement in the overall inference accuracy of the AI processor, that is, the inference accuracy for the categories of abnormalities and abnormal parts is improved.

A learning method according to an embodiment of the disclosure is the following learning method. AI machine learning is conducted by using a malfunction code output from a vehicle as input data for learning and by using an abnormal part of the vehicle in which an abnormality has occurred and a category of this abnormality as supervisor data. Then, AI that infers the abnormal part and the category of abnormality corresponding to an input malfunction code is generated.

By using the above-described learning method, it is possible to generate an AI model that can determine the abnormal part and the category of abnormality corresponding to a malfunction code that has not been input before.

It is thus possible to improve the assisting performance of an abnormality identification assist system using this method to assist with identifying the content of abnormality.

The abnormality identification assist system 1 illustrated in FIG. 5 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the abnormality identification assist system 1 including the code obtainer F1, inference controller F2, display controller F3, and first and second AI models 31 and 32. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 5.

1. An abnormality identification assist system comprising:
an artificial intelligence processor configured to use a malfunction code output from a vehicle as input and to infer an abnormal part of the vehicle in which an abnormality is occurring and a category of the abnormality;
at least one processor; and
a storage medium configured to store a program configured to be executed by the at least one processor,
wherein the program includes at least one command configured to cause the at least one processor to execute processing for inputting the malfunction code output from the vehicle into the artificial intelligence processor and instructing the artificial intelligence processor to infer the abnormal part in which the abnormality is occurring and the category of the abnormality corresponding to the input malfunction code.

2. The abnormality identification assist system according to claim 1, wherein the at least one command is configured to cause the at least one processor to execute inference result display processing for causing a display to display information indicating an inference result obtained by the artificial intelligence processor.

3. The abnormality identification assist system according to claim 2, wherein, in the inference result display processing, the at least one processor is configured to cause the display to display information indicating candidates for each of the abnormal part and the category of the abnormality which are obtained by the artificial intelligence processor as the inference result.

4. The abnormality identification assist system according to claim 1, wherein:
the artificial intelligence processor comprises
a first artificial intelligence model configured to learn to infer the category of the abnormality from the malfunction code output from the vehicle as a result of conducting machine learning by using the malfunction code as input data and the category of the abnormality as supervisor data, and
a second artificial intelligence model configured to learn to infer the abnormal part from a combination of the malfunction code output from the vehicle and the category of the abnormality as a result of conducting machine learning by using the malfunction code and the category of the abnormality as the input data and the abnormal part as the supervisor data; and
the first artificial intelligence model infers the category of the abnormality corresponding to the input malfunction code, which is a malfunction code input as the input data, while the second artificial intelligence model infers the abnormal part by using the input malfunction code and the category of the abnormality inferred by the first artificial intelligence model as the input data.

5. The abnormality identification assist system according to claim 4,
wherein the category of the abnormality comprises a plurality of categories of abnormalities to be inferred by the first artificial intelligence mode, and the abnormal part comprises a plurality of abnormal parts to be inferred by the second artificial intelligence model, and
wherein the categories of abnormalities are smaller in number than the abnormal parts.

6. A learning method comprising:
conducting machine learning for artificial intelligence by using a malfunction code output from a vehicle as input data for learning and by using an abnormal part of the vehicle in which an abnormality has occurred and a category of the abnormality as supervisor data; and
generating artificial intelligence configured to infer the abnormal part and the category of the abnormality corresponding to the input malfunction code.
